(19) United States
(12) Patent Application Publication
(10) Pub. No.: US 2017/0079245 A1
(43) Pub. Date: Mar. 23, 2017

(54) Dog leash with integrated clip mechanism

(71) Applicant: Anatoliy Omelchenko, Brooklyn, NY (US)

(72) Inventor: Anatoliy Omelchenko, Brooklyn, NY (US)

(21) Appl. No.: 15/267,679

(22) Filed: Sep. 16, 2016

Related U.S. Application Data
(60) Provisional application No. 62/220,506, filed on Sep. 18, 2015.

(51) Int. Cl. A01K 27/00

(52) U.S. Cl. CPC A01K 27/004

(57) ABSTRACT

The device disclosed within is a retractable dog leash with a handle that can open and close, locking around an object to restrain the body of the leash.

### CROSS-REFERENCE TO RELATED APPLICATION

This application is a non-provisional application that claims priority to U.S. patent application Ser. No. 62/220,506, filed Sep. 18, 2015, the disclosure of which is hereby incorporated by reference.

### FIELD

This invention relates to the field of pet leashes and more particularly to a dog leash with a mechanism to clip and unclip from objects.

### BACKGROUND

Dogs are an integral part of our lives. A dog may spend an entire day with its owner, from waking up, walking to work, taking breaks in the park, grocery shopping, and eating out. Leashes are the tool of choice to allow an owner to control a dog, keeping the dog safe and in the correct location.

Dogs are not allowed everywhere. For non-service dogs, a trip to the grocery store may require that the dog wait outside. This requires affixing the leash to a pole or bench to keep the dog from wandering off.

Or the owner may wish to take a break on a bench, and allow the dog to walk around, but without maintaining a constant grip on the leash.

What is needed is a leash for a dog that can be attached to objects, allowing the owner to maintain control over the dog, but without requiring constant holding by the user.

### SUMMARY

The device disclosed within is a retractable dog leash with a handle that can open and close, locking around an object to restrain the body of the leash.

The disclosed device includes two primary sections: a body and a handle.

The body is comprised of a housing into which the retractable leash is contained. The retraction of the leash is accomplished by a rotating wheel, around which the leash winds. The leash wheel is powered by a spring, which has one end affixed to the leash wheel and the other end affixed to the housing.

A sliding arm interfaces with teeth that are affixed to, or integral to, the leash wheel. The sliding arm is actuated by an external button that is positioned beneath the user's thumb. The position of the sliding arm controls whether the sliding arm slows the motion of the wheel, or locks the wheel to prevent any further motion.

When the wheel is locked the leash is prevented from winding or unwinding. This allows the user to control the length of the leash.

The leash cord enters and exits the housing through the leash guide ring. The leash guide ring acts to orient the leash cord as it enters the body, thus ensuring proper wrapping of the leash cord around the wheel.

The second section of the device is the handle. The handle is the means by which the leash may be locked around objects, maintaining the leash in a fixed location and freeing the hands of the user.

There are three primary embodiments of the handle.

The first embodiment includes a handle constructed of a stiff material. In this embodiment the handle is divided into a fixed section and a movable section. A hinge is located between the fixed section and movable section.

At the other end of the movable section opposite the hinge is a buckle or clip. By disengaging the buckle or clip the user may rotate the movable section, opening the handle to allow the leash to slip over an object. After the leash passes over the object, the handle is closed and clipped, securing the device to the object.

The preferred embodiment includes a buckle with an interlocking male and female portion. Other connection types may be substituted, such as a buckle with strap ratchet that interfaces with a strap, a magnetic catch, or other means of connecting.

The second embodiment also includes a handle divided into a fixed section and a movable section, but the hinge as an optional component. The fixed section is preferably constructed of a rigid, or non-flexible material. A rigid material is preferable because this section is likely to be gripped by the user's hand. Thus, a rigid connection to the body of the leash allows the user to maintain firm control over the device.

The fixed section transitions to a movable section. The movable section is made of a flexible material that is readily deformable. The transition between the fixed section and movable section may be a fixed point such as a hinge. Or the transition may be a fixed point at which the material changes from rigid to flexible, without a defined hinge. Or the transition may be gradual, with the handle progressing from the rigid material, to a portion that is partially rigid and partially flexible, and finally to an entirely flexible material.

A buckle or clip is used to connect the detachable section of the handle to the body.

In the third embodiment the entire handle, or substantially the entire handle, is flexible. In this embodiment there is no hinge, but instead the entire handle can flex to create an open space, allowing the handle to pass around objects. This design allows for greater versatility when determining how to open the handle and attach to an object.

In this embodiment there is still a buckle or clip at which the flexible section terminates. As in other embodiments, the buckle or clip may be other types of connector.

If a hinge is used, the hinge may be a defined hinge that is a mechanical part, or be comprised of the same, or similar, materials as the handle itself, forming a living hinge. A living hinge is a flexible hinge made from the same material as the pieces it connects. A living hinge is generally a plastic material.

While the preferred embodiment includes a buckle with a male and female portion, other connection types may be substituted, such as a buckle with strap ratchet that interfaces with a strap, a magnetic catch, or other means of connecting.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side view of a first embodiment in the closed position.

FIG. 2 illustrates a side view of the first embodiment in an open position.

FIG. 3 illustrates a partial cross-sectional view of the first embodiment in the closed position with the slide engaged.

FIG. 4 illustrates a partial cross-sectional view of the first embodiment in the closed position with the slide disengaged.

FIG. 5 illustrates a side view of a second embodiment in a closed position.

FIG. 6 illustrates a side view of the second embodiment in an open position.

FIG. 7 illustrates a side view of a third embodiment in an open position.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

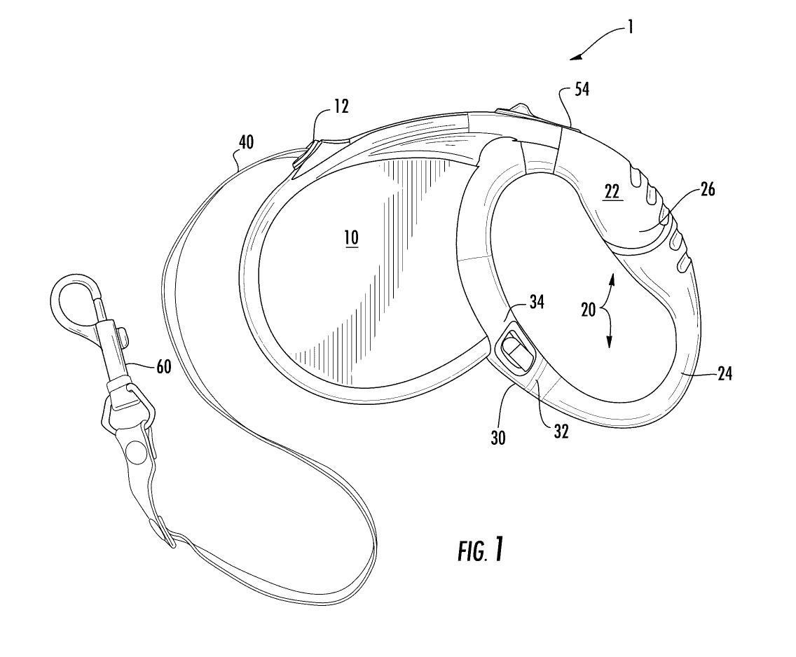

Referring to FIG. 1, a side view of a first embodiment in the closed position is shown. The leash with integrated clip 1 is comprised primarily of a body 10 and handle 20. The body 10 includes a leash guide ring 12 through which the leash cord 40 passes. The leash cord 40 ends in a hook 60.

The handle 20 includes handle fixed section 22 and handle movable section 24, joined by handle hinge 26. The handle moveable section 24 meets the body 10 at handle clip 30, which is comprised of clip male end 32 and clip female end 34.

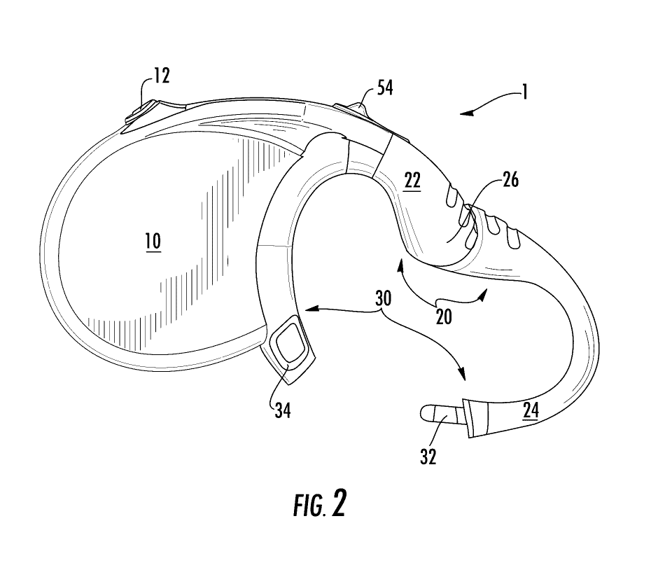

Referring to FIG. 2, a side view of the first embodiment in an open position is shown.

The handle clip 30 is disengaged, allowing the handle movable section 24 to rotate about the handle hinge 26. This allows the handle 20 to open, allowing the leash with integrated clip 1 to attach to an object.

The clip male end 32 and clip female end 34 are also shown.

The handle hinge 26 may also be located at the point at which the handle fixed section 22 meets the body 10. The result of such hinge placement is that the entire handle rotates about the hinge, creating a larger opening to surround objects. Stated differently, the entire handle 20 becomes a movable section, essentially eliminating the handle fixed section 22.

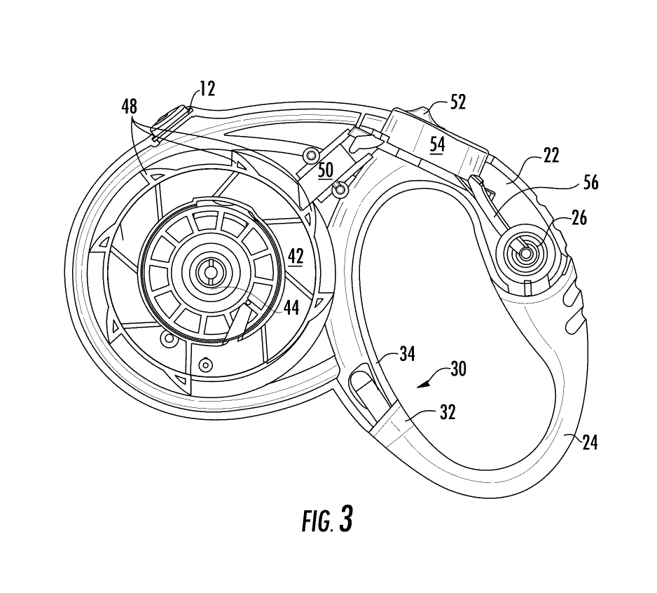

Referring to FIG. 3, a partial cross-sectional view of the first embodiment in the closed position with the slide engaged is shown.

The leash wheel 42 is powered by the internal spring 44. The sliding arm 50 moves to interface with locking teeth 48 of the leash wheel 42. The brake button 54 is depressed and released to move the sliding arm 50. Brake button spring 56 urges the brake button 54 upward, unless the brake lock 52 is engaged, which locks the brake button 56 in the engaged position.

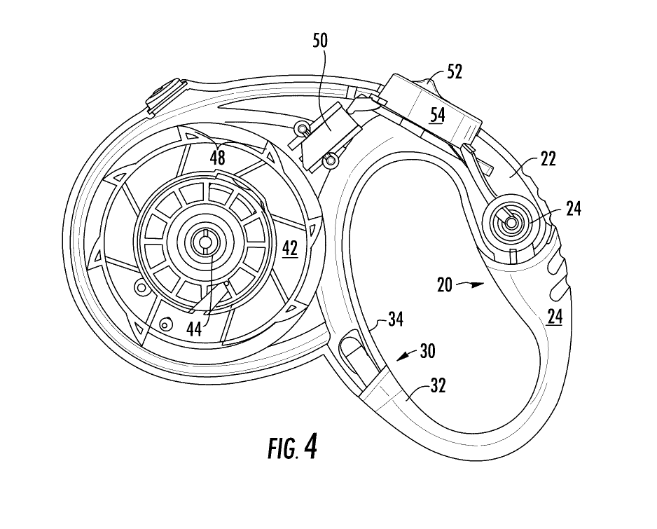

Referring to FIG. 4, a partial cross-sectional view of the first embodiment in the closed position with the slide disengaged is shown.

The brake button 54 is shown in an upward position, or unactuated position. The sliding arm 50 is in an upward position, thus the leash wheel 42 is free to rotate.

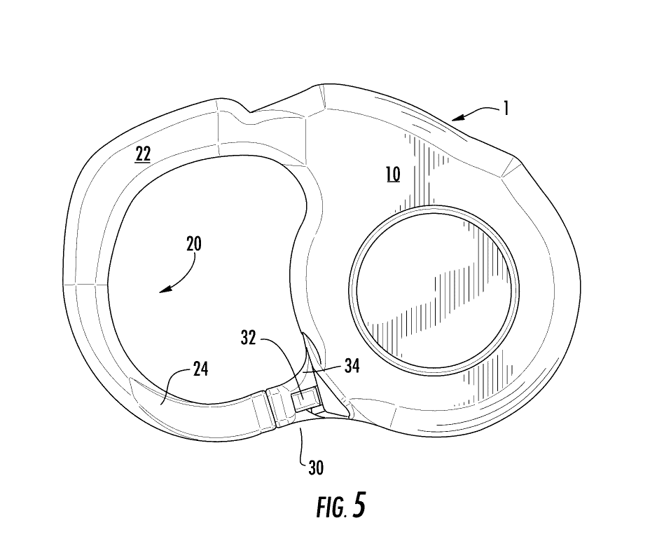

Referring to FIG. 5, a side view of a second embodiment in a closed position is shown. In this embodiment the handle fixed section 22 and handle movable section 24 do not require separation by a hinge. Instead, the handle moveable section 24 is a flexible material. Thus, when the handle clip 30 is disengaged the handle movable section 24 is free to move away from the body 10, opening the handle 20.

In the closed position the handle 20 forms a loop.

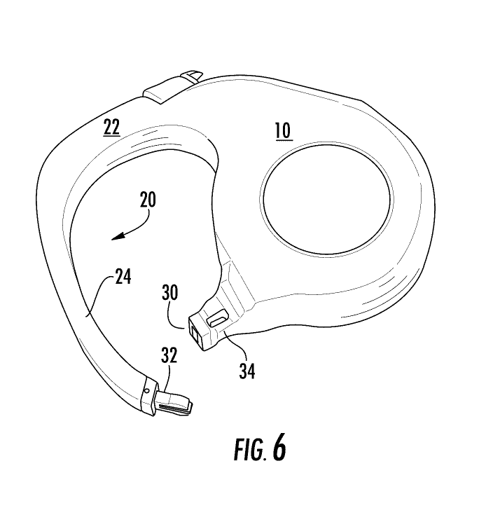

Referring to FIG. 6, a side view of the second embodiment in an open position is shown.

The handle movable section 24 is shown flexed away from the body 10, thereby creating an opening. In some embodiments the handle fixed section 22 is also flexible, making the entire handle 20 a flexible material.

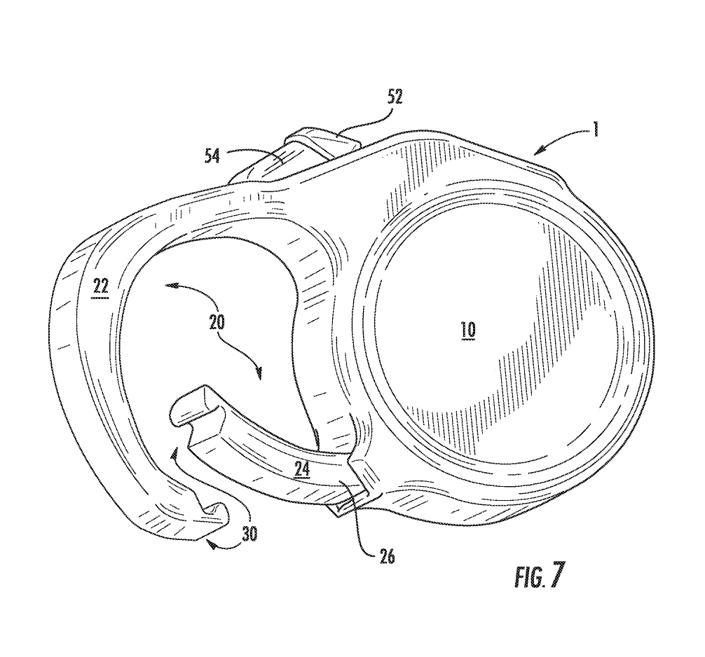

Referring to FIG. 7, a side view of a third embodiment in an open position is shown.

In this embodiment the handle hinge 26 is located at the connection between the body 10 and the handle movable section 24. The inward motions of the handle movable section 24 allows for simple attachment to objects by merely pressing the handle moveable section 24 against the object. This process is aided by the handle clip 30 being non-locking, instead held in place by a spring (not shown) within the handle hinge 26. Thus, the handle moveable section 24 readily moves inward, allowing the handle 20 to pass around the object. Once the object is clear of the handle clip 30, the handle moveable section 24 closes, capturing the leash with integrated clip 1.

The handle fixed section 24 comprises greater than one-half the length of the handle 20. But variations in handle length are anticipated.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A pet leash comprised of:
a. a body;
b. a handle directly affixed to the body;
c. the handle able to partially disengage from the body;
d. thereby allowing the handle to pass around an object and thus restrain the body of the leash.

2. The pet leash of claim 1, further comprising:
a. a hinge at a midpoint of the handle;
b. wherein the handle is divided into a fixed section and a movable section;
c. the movable section able to rotate with respect to the fixed section.

3. The pet leash of claim 1, further comprising:
a. a hinge at an end of the handle;
b. a connection point at a midpoint of the handle;
c. whereby the connection point is disengaged to allow rotation of the handle, allowing the handle to pass around an object.

4. The pet leash of claim 1, further comprising:
a. a hinge at a first end of the handle;
b. a buckle at a second end of the handle;
c. whereby the buckle is disengaged to allow rotation of the handle, allowing the handle to pass around an object.

5. The pet leash of claim 1, wherein the handle is divided into a fixed section and a flexible section;
a. the fixed section composed to a material that resists rotation with respect to the body;
b. the flexible section composed of a material that is readily movable with respect to the body;
c. the flexible section able to partially disengage from the body, allowing the handle to pass around an object.

6. A pet leash comprised of:
a. a body with looped handle;
b. the looped handle able to partially disengage from the body, allowing the looped handle to surround an object and affix the body to an object.

7. The pet leash of claim 6, further comprising:
a. a hinge at a connection between the looped handle and the body.

8. The pet leash of claim 6, further comprising:
a. a hinge at a midpoint of the looped handle.

9. The pet leash of claim 6, wherein the looped handle is partially composed of a flexible material that deforms, and thus rotates with respect to the body.

10. The pet leash of claim 6, wherein the looped handle is partially composed of a rigid material.

11. The pet leash of claim 9, wherein the looped handle is partially composed of a rigid material.

12. The pet leash of claim 10, wherein the looped handle is partially composed of a flexible material that deforms, and thus rotates with respect to the body.

13. The pet leash of claim 6, wherein the looped handle is partially composed of a rigid material;
a. the rigid material connected to a hinge;
b. the hinge allowing rotation of the rigid material with respect to the body.

14. A pet leash comprised of:
a. a body with a partially-detachable hinged handle;
b. whereby the partially-detachable hinged handle may be detached to pass around an object, then reattached to affix the pet leash to an object.

15. The pet leash of claim 14, wherein the partially-detachable hinged handle is detachable using a buckle.

16. The pet leash of claim 14, further comprising:
a. a hinge at a connection between the body and the partially-detachable hinged handle.

17. The pet leash of claim 14, further comprising:
a. a hinge between a first end and a second end of the partially-detachable hinged handle.

18. The pet leash of claim 14, further comprising:
a. a detachable connection between the body and the partially-detachable hinged handle.

19. The pet leash of claim 17, further comprising:
a. a detachable connection between the body and the partially-detachable hinged handle.
